(19) United States
(12) Patent Application Publication
(10) Pub. No.: US 2002/0188563 A1
(43) Pub. Date: Dec. 12, 2002

(54) Personal data recording device, personal data transaction method, personal data transaction system, and program thereof

(75) Inventors: Kazuhiko Isaji, Tokyo (JP); Hiroyuki Ogura, Yokohama-shi (JP)

Correspondence Address: John L. Rogitz, Rogitz & Associates, Suite 3120, 750 B Street, San Diego, CA, 92101, US

(73) Assignee: International Business Machines Corporation, Armonk, NY (US)

(21) Appl. No.: 10/162,817

(22) Filed: Jun. 3, 2002

(30) Foreign Application Priority Data
Jun. 12, 2001 (JP) JP2001-176518

(51) Int. Cl. G06F 17/60

(52) U.S. Cl. 705/41

(57) ABSTRACT

Purchase history data is held in a personal data recording device that includes a first recording region for recording credit data, a second recording region for recording purchase history data, and a third recording region for recording personal data. The service user records his own personal data in the third recording region, and when the user purchases merchandise, a credit transaction is performed by referring to credit data recorded in the first recording region. During the transaction, history data regarding the transaction is recorded in the second recording region. The user can sells the purchase history data and the personal data respectively recorded in the second and third recording regions.

### BACKGROUND OF THE INVENTION

The present invention relates to a personal data recording device, a personal data transaction method, a transaction system, and a program thereof. More particularly, the invention relates to a technology effective when applied to a transaction of personal data stored regarding merchandise purchase activities or latest and highly reliable personal data.

In the modern society, credit transactions using credit cards have been widespread. With regard to payment for merchandise purchased by use of a credit card, it is well known that purchase date and time, and a purchase price and the like are recorded by referring to credit data (e.g., card number) recorded in the card, and a seller makes a charge to a credit card company. On the other hand, the credit card company completes a transaction by withdrawing a cost of use from a service user's bank account on a predetermined settlement date. In recent years, a method of supplementing transaction credibility, e.g., making a reference to latest credit data based on magnetic data recorded in the card, has been employed. However, it is still basically a credit transaction carried out based on credit data.

On the other hand, credit cards with embedded semiconductor devices having rewritable recording functions have been used in recent years. Such cards may include a type which has a function of recording purchase history as well as credit data. Moreover, credit transactions are not limited to the use of such credit cards. For example, credit transactions may be carried out by recording credit data in portable telephone sets or personal digital assistants (PDA), and then using such portable terminals.

There may be a case where immediate settlement is carried out by recording bank account balance in a card or a portable terminal, and making payment from this balance limit. Strictly speaking, the immediate settlement based on bank account data is not a credit transaction. In the specification, however, a transaction carried out by use of a card of an immediate settlement system is also within a concept of credit transactions by including bank account data in credit data.

For a merchandise seller, it is important to obtain personal data for estimating a purchase trend of a consumer. Thus, collection of personal data is carried out by using various methods. For example, personal data and point of sales (POS) data stored in a credit card company, and data obtained by questionnaire surveys on streets are collected. Merchandise developments made after such basic data are subjected to various processing operations, and a group of purchasers is estimated, or business activities made after a scheduled group of purchasers for existing merchandise is extracted, become important marketing activities, which will determine merchandise sales. The personal data as such basic data becomes a basic factor for marketing.

Conventionally, however, no satisfactory activities have been made for collecting such personal data because of considerably high costs. For example, it is estimated that collection of personal data in Japan would generally cost around 10,000 yen per head in the fiscal year of 2000. The above-described activities for collecting personal data are unlikely as long as profits exceeding data collection costs cannot be guaranteed.

On the other hand, purchase history data generated following purchase activities using credit cards or the like has not been put to satisfactory use, though it is important as personal data. That is, such purchase history data may be stored at a store, where the merchandise purchase is made, but not obtained as purchase history inclusive of all stores. The purchase history data may be stored in a card company. However, such data are owned by the card company, and not often used by a service user himself. In short, the purchase history data to be originally used by the service user himself is not systematically utilized, and most is left unattended.

In addition, the purchase history data itself has a low data value. Its data value is increased if the purchase history data is obtained together with basic data specifying the service user, and personal attribute data necessary for estimating a purchase trend, e.g., an annual income, a family structure, and a preference of the service user. It is because such personal data become important factors for performing multiple regression analysis or the like.

### SUMMARY OF THE INVENTION

A discrimination technology enables a service user to enjoy an advantage of a profit return by setting his own personal data (containing purchase history data) as a target to be sold, a merchandise seller (service user of personal data) to have an opportunity of legally obtaining systematic and highly reliable personal data (containing purchase history data), and a service provider for providing a credit, e.g., a card company, to increase the number of service users (subscribers).

A personal data recording device of the invention comprises: a first recording region for recording credit data used when a service user purchases merchandise; a second recording region for recording purchase history data of the service user; and a third recording region for recording personal data of the service user. Note that recording of the credit data in the first recording region is permitted only to a service provider (also referred to as a credit providing organization in this specification) for providing credit data; recording of the purchase history data in the second recording region to the service provider and a merchandise seller (also referred to as a store in this specification); and recording of the personal data in the third recording region to the service user. By using such a device, the service user can store purchase history for each merchandise purchase in the second recording region, and record his personal data in the third recording region. In addition, the purchase history data and the personal data can be combined and set as a target to be transacted.

Note that merchandise generally denotes goods to be sold. In the specification, however, the merchandise also includes services to be sold. Thus, merchandise includes a concept of services unless specified otherwise. The merchandise seller includes not only an actual seller of goods at the store, but also a seller of goods and services at a virtual store on a network such as the Internet. In other words, the store in the specification is a concept including a virtual store on the network.

In the personal data recording device, a read of the purchase history data and the personal data can be limited by a password or other control codes managed by the service user, and the read range can be partitioned by a plurality of such control codes. Accordingly, the service user can set personal data of an intended range as a target to be transacted. Note that, for the personal data recording device, examples can be selected from a card having a data recording function, a personal digital assistant, a portable telephone set, a watch, and other portable devices.

The invention also provides a personal data transaction method using the above-described personal data recording device. When purchasing merchandise, the service user permits to copy the purchase history data in the second recording region, or the personal data in the third recording region. Then, in return, the service user obtains a profit in a form of a discount of merchandise, cash, a point, or the like. The personal data transaction method enables the store to legally obtain the personal data of the service user, while the service user to obtain a benefit such as a discount.

According to the invention, the personal data transaction method using the above-described personal data recording device includes the steps of: permitting to copy the purchase history data in the second recording region, or the personal data in the third recording region in response to a request from a data user; and providing a profit in a form of cash, a point, a discount of merchandise, or the like to the service user from the data user. Such a personal data transaction method enables the service user to independently transact personal data (including purchase history data) recorded in the device such as a card, and obtain a profit in a form of cash or the like in return for data disclosure.

Note that, according to the transaction method, the service user can enter his personal data in the third recording region by himself. Thus, latest personal data is entered to improve data reliability. The entered data can contain data such as an entry date and time, and the like. In addition, a range of copying the purchase history data or the personal data can be limited by a password or other control codes, and partitioned by a plurality of such control codes. Thus, it is possible to specify a range of personal data to be disclosed by the service user by use of a password or the like. For example, basic data containing an age, a residence area and the like may be transacted inexpensively. However, data including an annual income, a preference and the like, which is generally desired to be kept confidential, may have high transaction value. In such a case, it is possible to optionally set a disclosure range of personal data.

Moreover, according to the transaction method, when the service user purchases merchandise, purchase history of the merchandise is recorded in the second recording region. Such recording of the merchandise purchase data enables both personal data and purchase history data to be transacted. The personal data and the purchase history data are originally owned by the service user, and a profit obtained by a transaction is returned to the service user. Thus, since the service user is motivated more to subscribe to services, an increase of utilization fees (income) can be expected for a service provider such as a card company. Specifically, merchandise purchase should preferably be a credit transaction carried out by referring to the credit data in the first recording region.

The method of the invention can be comprehended as a system or a program.

### BRIEF DESCRIPTION OF THE DRAWINGS

For a more complete understanding of the present invention and the advantages thereof, reference is now made to the following description taken in conjunction with the accompanying drawings.

FIG. 1 is a conceptual view showing an example of a system for realizing a personal data transaction method according to an embodiment of the present invention.

FIG. 2 is a view showing an example of a personal data recording device 1.

FIG. 3 is a flowchart showing an example of a process, where a service user records personal data in the personal data recording device 1.

FIG. 4 is a flowchart showing an example of a process, where the service user purchases merchandise by using the personal data recording device 1.

FIG. 5 is a flowchart showing an example of a process, where the service user sells personal data when purchasing merchandise at a store 2.

FIG. 6 is a flowchart showing an example of a process, where the service user directly transacts personal data with a data purchaser.

FIG. 7 is a flowchart showing an example of a process, where the service user transacts his personal data and purchase history data through an intermediator.

### PREFERRED EMBODIMENTS OF THE INVENTION

Description will be made below in detail for an embodiment of the present invention with reference to the drawings. However, the present invention can be embodied in many different aspects and should not be interpreted so as to be limited to the described contents of this embodiment. Note that the same elements throughout the embodiment are denoted by the same reference numerals.

Although the method and the system will be mainly described in the embodiment below, the present invention can be embodied also as a program usable on a computer, as is apparent to those skilled in the art. Accordingly, the present invention can adopt an embodiment as hardware, an embodiment as software or an embodiment of a combination thereof. A program can be recorded in any computer readable medium such as a hard disk, a CD-ROM, an optical memory unit, or a magnetic storage.

In the embodiment below, general computer system can be used as a client system and a server system. A computer system usable in the embodiment includes hardware resources, which are generally provided in computer systems, having a central processing unit (CPU), a main storage device (main memory: RAM), a nonvolatile storage device (ROM), a coprocessor, an image accelerator, a cache memory, an input-output controller (I/O) and the like. The computer system can further include an external storage device such as a hard disk device, and communication means connectable to a network such as the Internet. The computer system includes various computers, e.g., a personal computer, a work station, a mainframe computer, and the like. In addition, proper communication means is provided to enable connection to a communication network such as the Internet.

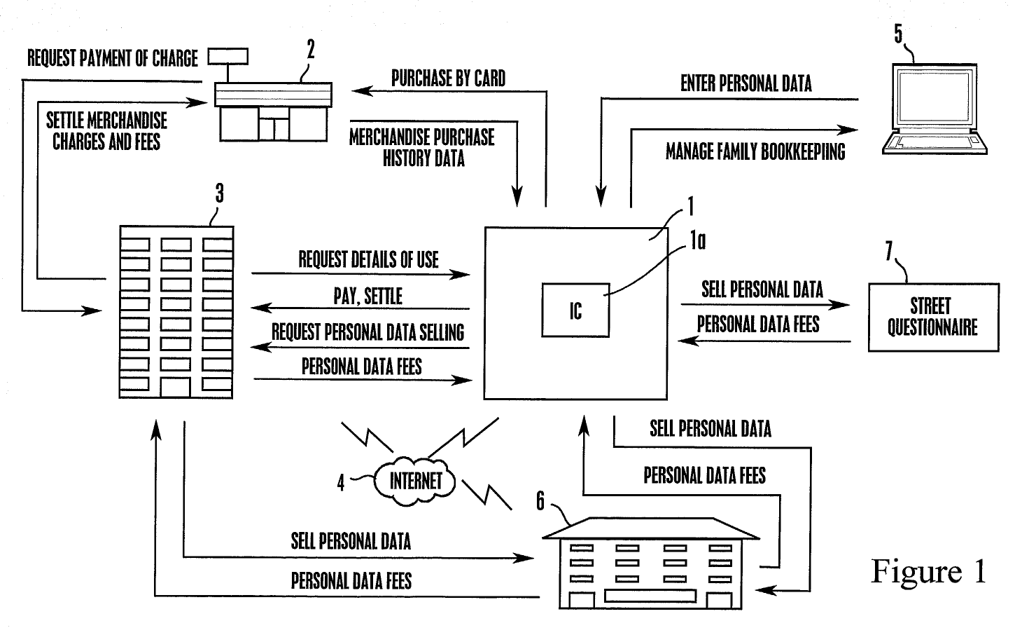

FIG. 1 is a conceptual view showing an example of a system for realizing a personal data transaction method according to an embodiment of the invention. According to this system, a service user owns a personal data recording device 1 for recording, for example, credit data such as a credit card, and purchases merchandise from a store 2 based on a credit transaction carried out by using the personal data recording device 1. The personal data recording device 1 has a function of offering credit data, which becomes a base not only for settlement by card payment, but also for a credit transaction. In this case, the store 2 obtains credit data from the personal data recording device 1 by using a data input-output (I/O) device such as a card reader. When the credit data authenticates credit of the service user, the store 2 hands over merchandise by card settlement. The store 2 charges the cost of the merchandise to a credit providing organization (e.g., credit company) 3. The credit providing organization 3 in turn pays the cost of the merchandise and fees to the store 2. Meanwhile, the credit providing organization 3 sends a detail statement and a bill to the service user, receives payment of a charge from a bank account or the like of the service user on a predetermined settlement date, and completes the transaction of merchandise purchase. Such a transaction using a credit card is not different in any way from the conventional merchandise purchase carried out by using a credit card.

According to the transaction method of the embodiment, when the service user purchases merchandise based on settlement by the personal data recording device 1, history of the merchandise purchase is recorded in the personal data recording device 1. The recording is automatically carried out by, for example, the data I/O device of the store 2. Data to be recorded may be a product name, a store name, a purchase date and time, a purchase price, and the like. Regarding such purchase history data, the data itself becomes a target for a transaction as described later.

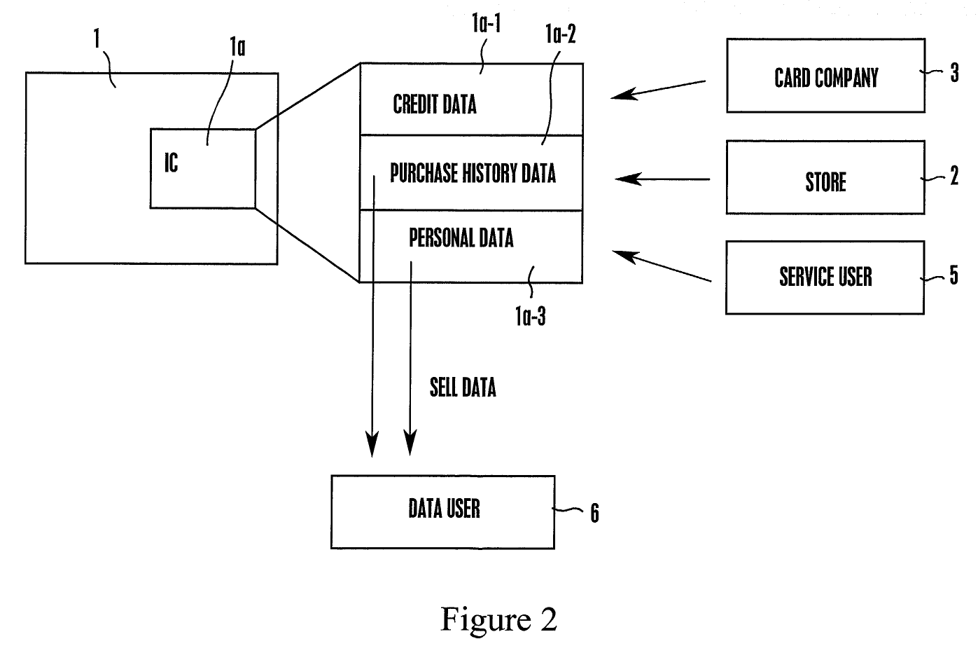

FIG. 2 is a view showing an example of the personal data recording device 1. The personal data recording device 1 includes a semiconductor integrated circuit 1a having a data recording function. Note that a credit card is shown here as an example of the personal data recording device 1. However, other examples are a personal digital assistant (PDA), a portable telephone set, a watch, a smart card, and the like. Other than the above semiconductor integrated circuit 1a, the personal data recording device 1 can include a magnetic recording medium, an optical recording medium, a magneto-optical recording medium or the like.

The semiconductor integrated circuit 1a includes a first recording region 1a-1 for recording credit data, a second recording region 1a-2 for recording purchase history data, and a third recording region 1a-3 for recording personal data.

The credit data recorded in the first recording region 1a-1 is permitted to be written only by the credit providing organization (e.g., credit company) 3 for providing credit, and read out by the store 2. As described above, the store 2 utilizes the credit data as data for judging credibility of a transaction partner in merchandise purchasing.

The purchase history data recorded in the second recording region 1a-2 is recorded by the store 2, and read out by the service user. When the store 2 sells merchandise, a transaction thereof is recorded in the second recording region 1a-2. Accumulation of transaction data recorded in the second recording region 1a-2 becomes purchase history data, and a part of personal data as a target to be transacted as described later. The purchase history data reflects a preference and a life style of the service user, thus becoming highly valuable data to a data user such as a marketer.

As the personal data recorded in the third recording region 1a-3, personal data of the service user who uses the personal data recording device 1 is recorded. The personal data can include a sex, an age, an occupation, an income, a hobby, an interest, and the like. Writing of personal data in the third recording region 1a-3 is permitted only to the service user, and this personal data is read out by the service user. The personal data thus recorded becomes a target to be transacted as described later, and its value as data can be increased if the personal data is transacted together with the above-described purchase history data. That is, the marketer analyzes the purchase history data for the purpose of predicting a purchase behavior of a consumer or the like, in this case, personal data regarding the consumer (service user) of the purchase behavior functions as important attribute data. It is because in order to predict a purchase behavior to particular merchandise, analysis while grasping a more specific consumer image enables prediction to be carried out with higher accuracy. The personal data and the purchase history data collected by data transactions by use of the embodiment become high-quality basic data for predicting and analyzing such a consumer behavior.

Recording or correction of the personal data in the third recording region 1a-3 is executed by a computer system 5 of the service user. That is, since the service user himself records his own personal data, its accuracy is guaranteed. In addition, since the recorded personal data is changed by the service user, if necessary, novelty and accuracy of the personal data are both guaranteed. For example, in the case of personal data by the credit company in the conventional art, data is limited to one at the time of card creation, and the data is hardly subjected to updating. According to the embodiment, however, since the personal data recorded in the third recording region 1a-3 is managed by the service user himself, novelty and accuracy of the data can be very high. In other words, the personal data targeted by the system of the embodiment can maintain high levels of novelty and accuracy unthinkable in the conventional art.

Recording formats of the first, second, and third recording regions 1a-1 to 1a-3 can be determined by the credit providing organization 3 as a card issuing source. In addition, for items contained in the personal data, rewriting thereof by the service user being unrecommended, they may be protected so as to place priority on the data of the credit providing organization 3.

Purchase history data and personal data stored for each merchandise purchasing become targets to be transacted, and various forms of transactions and uses can be considered. An example is a form of transaction, where the service user directly transacts the purchase history data and the personal data with a data user 6 who receives such purchase history data and personal data. That is, the service user allows the data user 6 to copy the purchase history data and the personal data recorded in his personal data recording device 1, and receives a profit in return.

Another example is a form of transaction, where the credit providing organization 3 such as a credit company intermediates in selling and buying purchase history data and personal data. That is, the credit providing organization 3 receives a request from the service user to sell the purchase history data and the personal data, and transacts the purchase history data and the personal data with the data user 6 according to his buying request. The data user 6 pays purchase history data and personal data fees to the credit providing organization 3 as prices for supplying data, and then the credit providing organization 3 pays data supplying fees to the service user. Note that an intermediator of purchase history data and personal data is not limited to the credit providing organization 3. Other specialized organizations or the like may also mediate the data. In addition, such transactions with the data user 6 or transactions through the credit providing organization 3 can be carried out through, for example, the Internet 4.

Alternatively, the service user can transact the purchase history data and the personal data in a manner of answering a questionnaire on a street or the like. For example, the personal data recording device 1 is connected to a card reader owned by a person, who carries out a street questionnaire. This person is then allowed to copy purchase history data and personal data, and the service user receives a profit in return. Such a questionnaire may be carried out by the data user 6 or a questionnaire trader on behalf of the data user 6.

Otherwise, the store 2 may wish to obtain purchase history data and personal data. In such a case, the store 2 can buy the purchase history data and the personal data of the service user as a merchandise purchaser from the personal data recording device 1 when the merchandise is sold and bought. In this case, a profit returned from the store 2 to the service user can be made by cash or the like, also by various other means such as a discount of a merchandise price, and issuance of a coupon and a point.

Furthermore, the purchase history data may be utilized by the service user himself. The service user can utilize the purchase history data for family bookkeeping, for example.

As apparent, the purchase history data and the personal data recorded in the personal data recording device 1 according to the embodiment can be transacted. The purchase history data conventionally left unattended can be stored, and sold to a person who needs it (data user 6 in this case). As a result, a new value is added to the data that has been simply discarded, and the service user can receive a profit by selling the data. Moreover, the service user can utilize the purchase history data for family bookkeeping.

On the other hand, the service user is motivated to make a merchandise purchase carried out by using the personal data recording device 1 (when a merchandise purchase is made by using the device, the amount of purchase history data is accordingly increased, resulting in a higher price of the data). Thus, the store can expect an increase of opportunities of merchandise purchases carried out by using the personal data recording device 1. As a result, opportunities of merchandise purchases at the store 2, where the personal data recording device 1 can be used, are increased, thereby increasing the number of customers who visit the store, and merchandise sales.

For the credit providing organization 3, requests for subscriptions to the personal data recording device 1 of the embodiment are increased, and thus a profit increase of annual subscription fees or the like can be expected. In other words, for the credit providing organization 3, it is possible to discriminate the services from those of a credit card or the like having only a credit function, and accordingly increase the number of subscribers.

In addition, for the data user 6, an opportunity of obtaining high-quality personal data is provided, making it possible to easily obtain highly reliable personal data at a reasonable price.

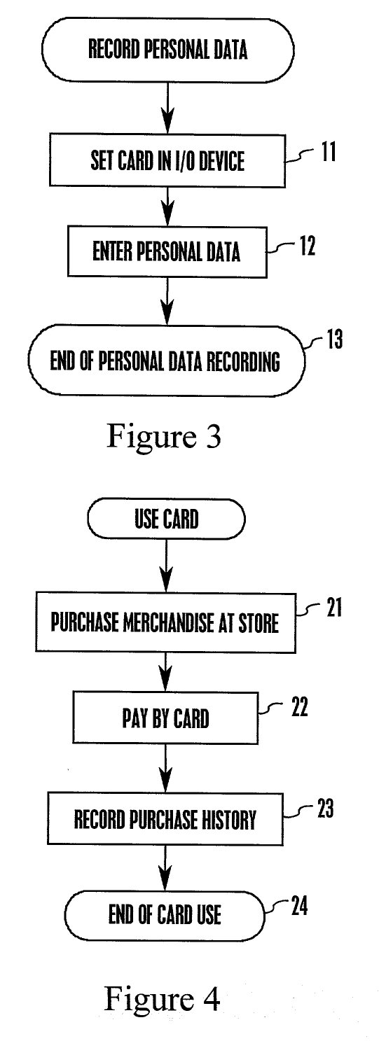

Next, description will be made for a transaction method using the personal data transaction system of the embodiment. FIG. 3 is a flowchart showing an example of a process, where the service user records his personal data in the personal data recording device 1. First, the service user sets a card (personal data recording device 1) in a data I/O device such as a card reader provided in his own computer system (step 11). Proper data is entered to an input field such as a name, an age, a sex, a family structure, an income or a hobby, which has been subjected to formatting beforehand by the credit providing organization 3 (step 12). After the entry of necessary data, the process is finished (step 13). Note that, in this case, the entered data is recorded in the third recording region 1a-3. The service user changes the personal data by a similar process if necessary. The entry or change of the personal data exemplified in this step is permitted only to the service user, and an access right for entry or change is provided by a proper password.

FIG. 4 is a flowchart showing an example of a process, where the service user purchases merchandise by using the personal data recording device 1. First, the service user purchases merchandise at the store 2 by using the personal data recording device 1 of the embodiment (step 21). The store 2 reads out credit data recorded in the first recording region 1a-1 of the personal data recording device, and makes settlement in exchange for the merchandise if the credit data is credible (step 22). Credibility of the credit data can be measured by credibility of a credit providing organization, and a valid duration of credit data. In addition, for settlement, the store 2 can request the service user to enter a signature or a password. Here, an example of settlement based on the credit data is shown. However, settlement may be made by, for example, a system of immediate settlement with a bank account while referring to the bank account balance or the like of the service user. Subsequently, the store 2 records a transaction content of the current merchandise purchase as purchase history in the second recording region 1a-2 of the personal data recording device 1 (step 23). Each transaction of merchandise purchases is recorded for each merchandise purchase, and stored as purchase history data in the second recording region 1a-2. A transaction content to be recorded may include a purchase date and time, a product name, a purchase price and the like.

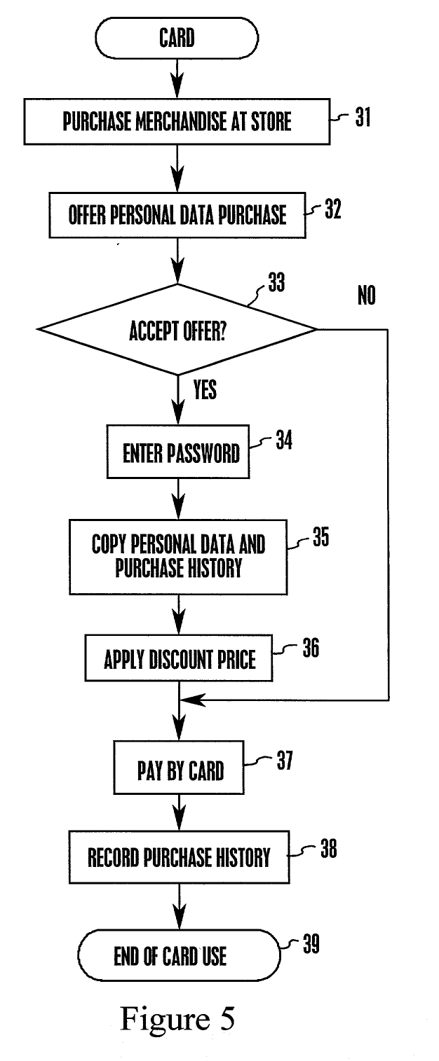

FIG. 5 is a flowchart showing an example of a process, where the service user sells his personal data when purchasing merchandise at the store 2. As in the case shown in FIG. 4, the service user purchases the merchandise at the store 2 by using the personal data recording device 1 (step 31). If the store 2 wishes to obtain the personal data of the service user, an offer of buying the personal data is received (step 32). Determination is made as to whether the service user accepts the offer or not (step 33). If he accepts the offer, the service user enters a password (step 34). For the entry of the password, for example, a card reader provided in the store 2 is used. The password is managed by the service user, and the card reader is permitted to copy the personal data and the purchase history data only when a proper password is entered (step 35).

The number of passwords is not limited to one, and plural kinds of passwords may be prepared. In such a case, it is possible to control a disclosure range of the personal data and the purchase history data according to passwords. For example, control is performed in a manner that in the personal data, items excluding ones capable of specifying a person, such as a name, an address, a telephone number, and the like are permitted to be disclosed when a password A is entered, and all items are disclosed when a password B is entered. Other than the above, needless to say, a range of disclosure can be optionally set. In addition, kinds of passwords can be increased more.

When the service user permits to copy the personal data and the purchase history data as described above, in return, for example, discount price of the purchased merchandise is provided (step 36). Needless to say, in place of such a discount price of the purchased merchandise, a profit can be obtained in other forms, e.g., cash, a coupon, a point, and the like.

Subsequently, settlement is carried out as in the case shown in FIG. 4 (step 37). Note that, if the service user does not accept the offer in step 33, the process proceeds to step 37, where settlement similar to that of FIG. 4 is carried out (step 37). As in the case shown in FIG. 4, the purchase history is recorded (step 38), and the process is finished (step 39).

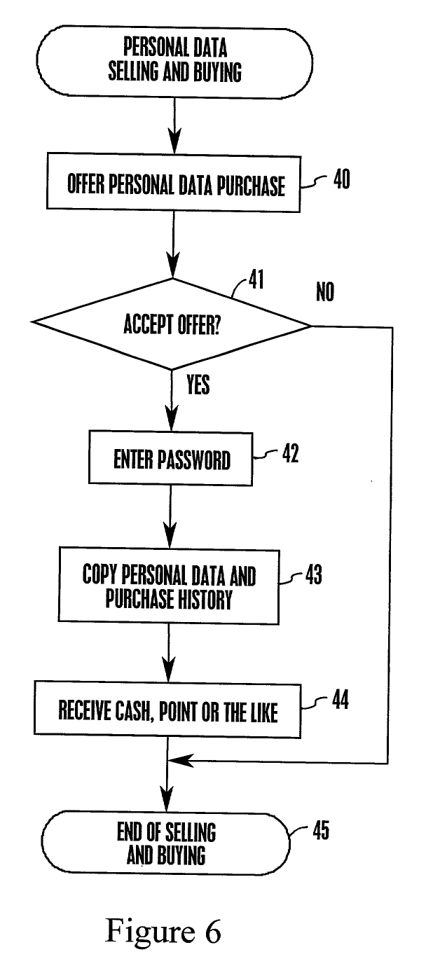

FIG. 6 is a flowchart showing an example of a process, where the service user directly transacts his personal data with the data user. The service user receives an offer of buying the personal data from the data user in a form of answering a questionnaire on a street, or through the Internet (step 40), and determines whether or not to accept the offer (step 41). When accepting the offer, the service user sets the personal data recording device 1 in an I/O device such as a card reader, enters a password (step 42), and then permits the personal data and the purchase history data to be copied (step 43). Regarding the I/O device, a device carried by a questionnaire collector is used in the case of street questionnaire, and an I/O device provided in the service user's computer system is used in the case of a transaction through the Internet. The password permits access to the personal data and the purchase history data, and a disclosure range of data items can be controlled depending on the kind of a password, which are the same as in the case described above with reference to FIG. 5.

Subsequently, in return for copying the personal data and the purchase history data, the service user receives cash, a point, or the like (step 44).

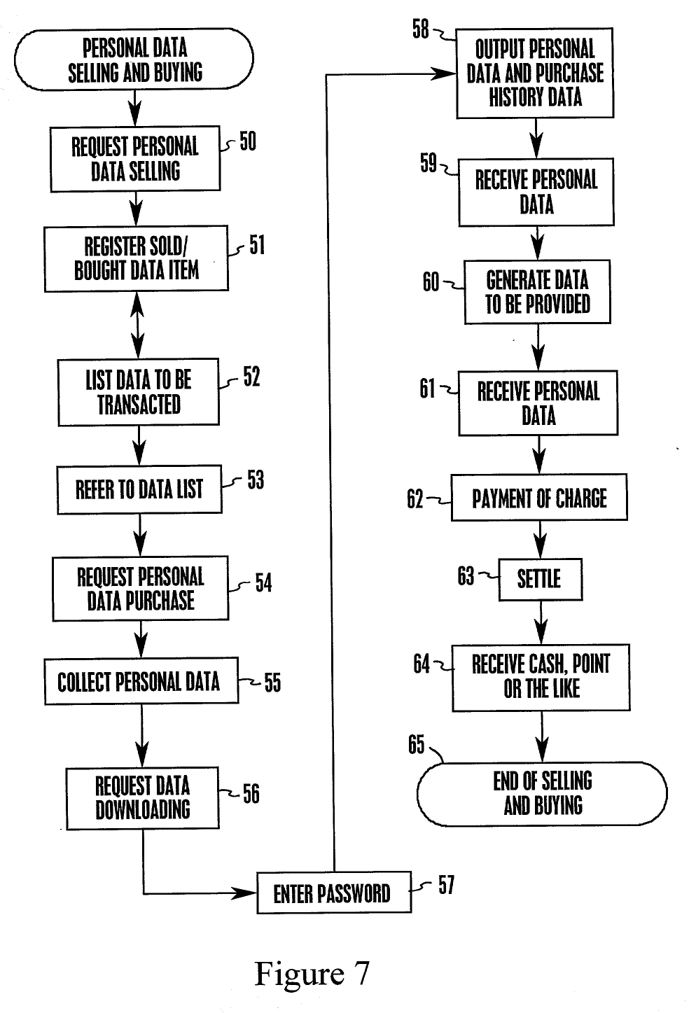

FIG. 7 is a flowchart showing an example of a process, where the service user transacts his personal data and purchase history data through an intermediator. In FIG. 7, a left side shows a process for the service user; a center a process for the intermediator; and a right side a process for the data user.

First, the service user sends a selling request of his own personal data and purchase history data to the intermediator (step 50). The selling request can include a range of data items possible to be provided, and corresponding prices. Upon having received the request, the intermediator registers data items to be sold/bought (step 51). In this case, the intermediator can be a credit providing organization 3 shown in FIG. 1. The intermediator makes a list of data possible to be transacted, from many registered data items to be sold/bought, and makes the list public (step 52).

The data user refers to the list of data possible to be transacted (step 53), and issues a purchase request for the listed-up data (step 54). Upon having the purchase request from the data user, the intermediator starts collection of personal data and purchase history data (step 55). The intermediator issues a data downloading request to each service user related to the purchase request of the data user (step 56). Upon having received the downloading request, each service user enters a password (step 57), and accordingly outputs his personal data and purchase history data from the personal data recording device 1 (step 58). Note that it is possible to control a range of data to be outputted by a password as in the foregoing case.

The intermediator receives the data items from each service user (step 59), and collects these items to generate data to be provided (step 60). The generated data to be provided is sent to the data user, and the data user receives the data (step 61). The data user pays a price of the received data (step 62). After settlement by the intermediator (step 63), a profit in a form of cash, a point, or the like is provided to each service user according to the provided data. Each service user receives the profit (step 64), and terminates selling and buying (step 65).

As described above, according to the personal data transaction system or method of the embodiment, advantages can be provided to all of the credit providing organization 3 as an issuer of the personal data recording device 1, the store 2 for selling merchandise by using this device, the service user, and the data user who wishes to obtain personal data.

That is, for the service user, a sales profit can be expected by setting his personal data as a target to be sold/bought. For the store 2, an increase of merchandise sales can be expected by promoting use of the system of the invention. For the credit providing organization 3, an increase of subscription fees can be expected by enhancing subscriber services, and discriminating from other service organizations so as to increase the number of subscribers. For the data user, highly reliable and high-quality purchase history data and its related personal data can be easily obtained at reasonable prices.

The preferred embodiment of the present invention has been described in detail. However, it should be understood that the invention is not limited to the embodiment, and various changes and modifications can be made within the spirit of the invention.

The present invention is advantageous in the following respects. That is, it is possible to provide the technology for holding conventionally discarded purchase history data in a state of being easily utilized by the service user who is an original owner. It is also possible to utilize data obtained by combining the purchase history data with the personal data containing the age, the annual income, the family structure, the preference and the like of the service user, as a target to be sold/bought. In addition, it is possible to facilitate selling and buying (transaction) of the purchase history data and the personal data. In other words, by setting his personal data (including purchase history data) as a target to be sold, the service user can enjoy an advantage of obtaining a profit in return. For the personal data service user (data user), an opportunity of legally and systematically obtaining highly reliable personal data (including purchase history data) can be provided. For the service provider for providing credit, such as a card company, the discrimination technology for increasing the number of service users (subscribers) can be provided.

Although the preferred embodiments of the present invention have been described in detail, it should be understood that various changes, substitutions and alternations can be made therein without departing from spirit and scope of the inventions as defined by the appended claims.

What is claimed is:

1. A personal data recording device comprising:
a first recording region for recording credit data used when a service user purchases merchandise;
a second recording region for recording merchandise purchase history data of the service user; and
a third recording region for recording personal data of the service user.

2. The personal data recording device according to claim 1, wherein recording of the credit data in said first recording region is permitted only to a service provider for providing the credit data, recording of the purchase history data in said second recording region is permitted to the service provider and a merchandise seller, and recording of the personal data in said third recording region is permitted to the service user.

3. The personal data recording device according to claim 1, wherein a read of the purchase history data and the personal data is limited by a control code managed by the service user.

4. The personal data recording device according to claim 3, wherein a range capable of the read of the purchase history data and the personal data is partitioned by a plurality of the control codes.

5. The personal data recording device according to claim 1, wherein said personal data recording device is a portable device.

6. A personal data transaction method using a personal data recording device, the personal data recording device including a first recording region for recording credit data of a service user, a second recording region for recording purchase history data of the service user, and a third recording region for recording personal data of the service user, said method comprising:
recording purchase history of merchandise in said second recording region when the service user purchases the merchandise; and
permitting to copy one of the purchase history data in said second recording region and the personal data in said third recording region in response to a request from one of a merchandise seller and a data user.

7. A personal data transaction method using a personal data recording device, the personal data recording device including a first recording region for recording credit data of a service user, a second recording region for recording purchase history data of the service user, and a third recording region for recording personal data of the service user, said method comprising:
recording purchase history of merchandise in said second recording region when the service user purchases the merchandise; and
permitting to copy both of the purchase history data in said second recording region and the personal data in said third recording region in response to a request from one of a merchandise seller and a data user.

8. The personal data transaction method according to claim 7, further comprising allowing the service user to enter the personal data of the service user in said third recording region.

9. The personal data transaction method according to claim 7, wherein a range of copying one of the purchase history data and the personal data is limited by a control code, and partitioned by a plurality of the control codes.

10. The personal data transaction method according to claim 7, wherein in return for permission of the copying, a profit is provided to the service user in a form including cash, a point, a discount of merchandise.

11. The personal data transaction method according to claim 7, wherein purchase of the merchandise by the service user is a credit transaction carried out by referring to the credit data in said first recording region.

12. A personal data transaction system using a personal data recording device, the personal data recording device including a first recording region for recording credit data of a service user, a second recording region for recording purchase history data of the service user, and a third recording region for recording personal data of the service user, said system comprising:
means for recording purchase history of merchandise in said second recording region when the service user purchases the merchandise; and
means for permitting to copy one of the purchase history data in said second recording region and the personal data in said third recording region in response to a request from one of a merchandise seller and a data user. 13. A personal data transaction system using a personal data recording device, the personal data recording device including a first recording region for recording credit data of a service user, a second recording region for recording purchase history data of the service user, and a third recording region for recording personal data of the service user, said system comprising:
means for recording purchase history of merchandise in said second recording region when the service user purchases the merchandise; and
means for permitting to copy both of the purchase history data in said second recording region, the personal data in said third recording region in response to a request from one of a merchandise seller and a data user.

14. The personal data transaction system according to claim 13, further comprising means for allowing the service user to enter the personal data of the service user in said third recording region.

15. The personal data transaction system according to claim 13, wherein a range of copying one of the purchase history data and the personal data is limited by a control code, and partitioned by a plurality of the control codes.

16. The personal data transaction system according to claim 13, wherein in return for permission of the copying, a profit is provided to the service user in a form including one of cash, a point, and a discount of merchandise.

17. The personal data transaction system according to claim 13, wherein purchase of the merchandise by the service user is a credit transaction carried out by referring to the credit data of said first recording region.

18. A computer program product, in a computer readable medium, for a transaction of personal data by using a personal data recording device, the personal data recording device including a first recording region for recording credit data of a service user, a second recording region for recording purchase history data of the service user, and a third recording region for recording personal data of the service user, said computer program product comprising:
instructions for recording purchase history of merchandise in said second recording region in said second recording region when the service user purchases the merchandise; and
instructions for permitting to copy one of the purchase history data in said second recording region and the personal data in said third recording region in response to a request from one of a merchandise seller and a data user.

19. A computer program product in a computer readable medium, for a transaction of personal data by using a personal data recording device, the personal data recording device including a first recording region for recording credit data of a service user, a second recording region for recording purchase history data of the service user, and a third recording region for recording personal data of the service user, said computer program product comprising:
instructions for recording purchase history of merchandise in said second recording region in said second recording region when the service user purchases the merchandise; and
instructions for permitting to copy both of the purchase history data in said second recording region and the personal data in said third recording region in response to a request from one of a merchandise seller and a data user.
